(19) United States
(12) Patent Application Publication
(10) Pub. No.: US 2026/0192921 A1
(43) Pub. Date: Jul. 9, 2026

(54) SYSTEM FOR TRANSFER OF PAYLOAD BETWEEN TRANSPORTATION PLATFORMS

(71) Applicant: Airborne Fidelity Private Limited, Bangalore (IN)

(72) Inventors: Shadab Ahmad Ansari, Bangalore (IN); Mahesh Kumar Saraswat, Bangalore (IN)

(73) Assignee: Airborne Fidelity Private Limited, Bangalore, KA (IN)

(21) Appl. No.: 19/132,733

(22) PCT Filed: Nov. 24, 2023
(86) PCT No.: PCT/IB2023/061868

§ 371 Date: May 23, 2025

(30) Foreign Application Priority Data
Nov. 25, 2022 (IN) 202241068029

(51) Int. Cl. B64D 1/00; B64U 10/14; B64U 101/64

(52) U.S. Cl. CPC B64D 1/00; B64U 10/14; B64U 2101/64

(57) ABSTRACT

The disclosed invention relates to a system (100) enabling mid-air payload transfer between unmanned aerial vehicles (UAVs). The system (100) includes a pair of Transfer Container Modules (TCMs) (102). Each TCM (102) includes receptacle (104) with slots (106) for payload cases, sliders (108) with engaging means, and flexible links for inter-UAV transfer. The system (100) incorporates gimbals (126) for rotational freedom and a streamlined mid-air transfer process. The engaging means (110) includes first fingers (116) configured to expand and collapse, and a sleeve comprises one or more flaps such that, the first fingers, when the first fingers expand, engage with the one or more flaps to move the flaps to an expanded flap position, and the first fingers and the flaps function as a means to couple the sleeve (112) with the payload case.

### TECHNICAL FIELD

The present disclosure relates to the field of transportation of a payload. In particular, it pertains to the mid-air payload transfer between transportation platforms, such as unmanned aerial vehicles (UAVs).

### BACKGROUND

Background description includes information that may be useful in understanding the present invention. It is not an admission that any information provided herein is prior art relevant to the presently claimed invention, or that any publication expressly or implicitly referenced is prior art.

In the contemporary landscape of cargo transportation systems encompassing diverse modalities, integrating unmanned aerial vehicles (UAVs), including drones and quadcopters, has introduced a paradigm shift in operational capabilities. However, a need for dedicated infrastructure exists to facilitate mid-air payload transfers between UAVs during their aerial missions. This deficiency becomes particularly salient when considering exigencies requiring real-time cargo adjustments, such as exchanging charged batteries between UAVs to sustain uninterrupted airborne operations.

Despite efforts to address related challenges, extant technologies must squarely address the nuanced demands inherent in mid-air payload transfer scenarios. For instance, automatic air-to-air refueling mechanisms, which establish physical links between flying aircraft for in-flight refueling, are confined to liquid fuel transfer. Concurrently, automatic battery swapping platforms allow for the exchange of drone batteries upon landing. However, their efficacy diminishes when confronted with the imperative for mid-air operations, mandating UAVs to return for battery replacements. Even widely utilized drone delivery systems, which tether payloads under the fuselage for point-to-point transportation, need more sophistication for mid-air payload transfers between UAVs.

Consequently, there is a need to provide an improved mechanism for mid-air payload transfer between unmanned aerial vehicles. Such an innovative solution would not only fill the gap in what UAVs can do but also usher in new operational efficiency and adaptability dimensions. These advancements, in turn, have profound implications for optimizing cargo transport, surveillance, and other applications contingent on the seamless exchange of payloads during UAV flight operations.

Therefore, there is a need to develop a mechanism for the transfer of payload from one transportation platform to another transportation platform while both are airborne and provide a system for the transfer of payload between transportation platforms.

### OBJECTS OF THE INVENTION

An object of the present disclosure is to provide a system for mid-air payload transfer between unmanned aerial vehicles (UAVs).

An object of the present disclosure is to provide a Transfer Container Module (TCM) with receptacles, slots, and a slider, optimizing the accommodation and transfer of payload cases.

An object of the present disclosure is to incorporate an engaging means within the TCM, equipped with first and second fingers, to enable controlled coupling and release of payload cases and to grip the flexi link.

An object of the present disclosure is to provide a transfer means, slidable along the engaging means, to efficiently carry and transfer payload cases between UAVs.

An object of the present disclosure is to provide a device with second fingers at the free end of the engaging means, facilitating the controlled capture and release of the flexible link during the entire payload transfer process.

An object of the present disclosure is to incorporate tension-adjusting devices within the TCM, serving to release and regulate the tension in the flexible link during mid-air payload transfer.

### SUMMARY

Aspects of the present disclosure relate to the transportation of a payload. In particular, it pertains to the transfer of payload mid-air between transportation platforms, such as unmanned aerial vehicles (UAVs).

In an aspect, the present disclosure provides a system for the mid-air transfer of a payload from one unmanned aerial vehicle (UAV) to another. The system includes a pair of transfer container modules (TCM), and each of the TCM includes a plurality of receptacles, each receptacle configured to accommodate a payload case holding the payload and having an open end for entry or exit the payload case. The TCM includes a plurality of slots configured on the TCM along the length of each of the receptacles, and the plurality of slots provides access to the desired payload case for coupling a transfer means with the payload case. Further, the TCM includes a slider configured to move along a transverse plane of the TCM, and the slider includes an engaging means and is configured to move along with the slider to align with one of the plurality of slots. Furthermore, the TCM includes a flexible link extending from a free end of the engaging means to facilitate the transfer of the payload case from one UAV to another UAV by sliding of the sleeve along with the coupled payload case along the engaging means and the flexible link. The system further includes a sleeve slidably configured with the engaging means and functioning as the transfer means to couple with the desired payload case.

In an embodiment, the TCM may include the engaging means including a set of first fingers configured to expand and collapse, and the sleeve includes one or more flaps such that, the first fingers, when the first fingers expand, engage with the one or more flaps to move the flaps to an expanded flap position, wherein the first fingers and the flaps function as a means to couple the sleeve with the payload case.

In an embodiment, the payload case includes a female coupling means that project out from the corresponding slot, and the sleeve comprises male coupling means fixed to the one or more flaps of the sleeve such that when the flaps move from the expanded flap position to a collapsed flap position, the male engaging means engage with the female engaging means to couple the payload case with the sleeve

In an embodiment, one of the TCMs of the pair of TCMs may include a tension regulating unit configured with the engaging means to release/retract the flexible link, as well as to adjust a tension in the flexible link after a link is established between one unmanned aerial vehicle (UAV) to another.

In an embodiment, the flexible link from the tension regulating unit to the free end of the engaging means is accommodated within the engaging means.

In an embodiment, the system may include one or more gimbals mechanically coupling the one or more TCMs of the pair of TCMs to the corresponding UAVs, and the gimbal provides free or powered degrees of freedom of rotation to the corresponding TCM about one or more rotational axes.

In an embodiment, the system may include a mass adjuster unit configured to dynamically adjust the off-centring of the center of mass during the reception or release of a payload case.

In another aspect, the present disclosure provides a sleeve for facilitating the mid-air transfer of a payload from one unmanned aerial vehicle (UAV) to another UAV. The sleeve may include a hollow housing slidably configured with an engaging means of a Transfer Container Module coupled to a UAV. The sleeve includes one or more flaps pivotally fixed to the housing for movement between an extended position and a collapsed position, and biased to remain in the closed position and a male coupling means fixed to the one or more flaps of the sleeve.

In an embodiment, when a set of first fingers of the engaging means are moved to an expanded position, the set of first fingers engage with one or more flaps to move the flaps to the expanded flap position, and when the set of first fingers are moved back, the one or more flaps move back to the collapsed flap position under a biasing force.

In an embodiment, when the one or more flaps move to the collapsed flap position, the male coupling means engage with the female coupling means to couple the payload case with the sleeve such that when the sleeve moves along the engaging means and a flexible link coupled to the engaging means, the payload case is carried from the UAV to another UAV to which other end of the flexible link is coupled.

In an embodiment, the sleeve may include rollers to enable smooth movement of the sleeve over the engaging means and the flexible link.

In an embodiment, the rollers are powered for an assisted movement of the sleeve along with the coupled payload case.

In an embodiment, the housing may include one or more windows through which the set of first fingers of the engaging means move to the expanded position to engage with one or more flaps.

In another aspect, the present disclosure provides a device for establishing a link between a first Unmanned Aerial Vehicle (UAV) and a second UAV for mid-air transfer of a payload between the UAVs. The device includes a transfer container module (TCM) configured with each of the first and the second UAV. Each of the TCM includes an engaging means. The device includes a tension regulating unit configured with the TCM of one of the first and the second UAV. The tension regulating unit is configured to release/retract a flexible link as well as to adjust a tension in the flexible link after a link is established between the first UAV and the second UAV, such that the flexible link passes through the engaging means of the corresponding TCM with a free end of the flexible link hanging out of a free end of the engaging means. The device further includes a set of second fingers provided at a free end of the engaging means of the TCM of the other of the first and the second UAV. The set of second fingers are configured to move between an open position and a closed position to capture the flexible link.

In an embodiment, the other of the first and the second UAV includes a V-shaped guide configured to direct the flexible link towards the free end of the engaging means.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1A illustrates an exemplary front perspective view of a transfer container module (TCM), in accordance with an embodiment of the present disclosure.

FIG. 1B illustrates an exemplary rear perspective view of (TCM), in accordance with an embodiment of the present disclosure.

FIG. 2A-2D illustrate an exemplary engaging means configured with TCMs, in accordance with an embodiment of the present disclosure.

FIG. 3 illustrates an exemplary perspective view of a sleeve, in accordance with an embodiment of the present disclosure.

FIG. 4A-4B illustrates an exemplary sleeve showcasing its operation, in accordance with an embodiment of the present disclosure.

FIG. 5 illustrates an exemplary block diagram of a system with a ground station for controlling the system, in accordance with an embodiment of the present disclosure.

FIG. 6A-6B illustrates an exemplary view of TCM with gimbal operation, in accordance with an embodiment of the present disclosure.

FIG. 7A-7C depict various stages of the payload case transfer between the TCMs of UAV-1 and UAV-2, in accordance with an embodiment of the present disclosure.

FIG. 8 depict V-shaped guide configured to direct the flexible link towards the free end of the engaging means, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

Embodiment herein relates to a system for the mid-air transfer of a payload from one unmanned aerial vehicle (UAV) to another. The system includes a pair of transfer container modules (TCM), and each of the TCM includes a plurality of receptacles, each receptacle configured to accommodate a payload case holding the payload and having an open end for entry or exit the payload case. The TCM includes a plurality of slots configured on the TCM along the length of each of the receptacles, and the plurality of slots provides access to the desired payload case for coupling a transfer means with the payload case. Further, the TCM includes a slider configured to move along a transverse plane of the TCM, and the slider includes an engaging means and is configured to move along with the slider to align with one of the plurality of slots.

Furthermore, the TCM includes a flexible link extending from a free end of the engaging means to facilitate the transfer of the payload case from one UAV to another UAV by sliding of the sleeve along with the coupled payload case along the engaging means and the flexible link. The system further includes a sleeve slidably configured with the engaging means and functioning as the transfer means to couple with the desired payload case.

Another embodiment herein relates to a sleeve for facilitating the mid-air transfer of a payload from one unmanned aerial vehicle (UAV) to another UAV. The sleeve may include a hollow housing slidably configured with an engaging means of a Transfer Container Module coupled to a UAV. The sleeve includes one or more flaps pivotally fixed to the housing for movement between an extended position and a collapsed position, and biased to remain in the closed position and a male coupling means fixed to the one or more flaps of the sleeve. When a set of first fingers of the engaging means are moved to an expanded position, the set of first fingers engage with one or more flaps to move the flaps to the expanded flap position, and when the set of first fingers are moved back, the one or more flaps move back to the collapsed flap position under a biasing force.

Another embodiment herein relates to a device for establishing a link between a first Unmanned Aerial Vehicle (UAV) and a second UAV for mid-air transfer of a payload between the UAVs. The device includes a transfer container module (TCM) configured with each of the first and the second UAV. Each of the TCM includes an engaging means. The device includes a tension regulating unit configured with the TCM of one of the first and the second UAV. The tension regulating unit is configured to release/retract a flexible link as well as to adjust a tension in the flexible link after a link is established between the first UAV and the second UAV, such that the flexible link passes through the engaging means of the corresponding TCM with a free end of the flexible link hanging out of a free end of the engaging means. The device further includes a set of second fingers provided at a free end of the engaging means of the TCM of the other of the first and the second UAV. The set of second fingers are configured to move between an open position and a closed position to capture the flexible link.

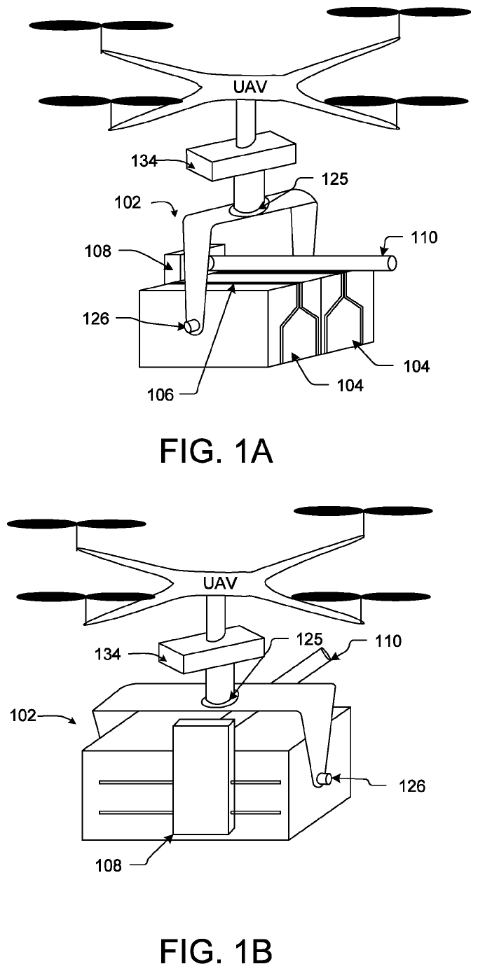

It is to be further appreciated that though the exemplary illustrations of FIGS. 1A to 8 depicts the present invention for mid-air transfer of a payload from one unmanned aerial vehicle (UAV) to another, practical applications extend beyond, and the system configuration may not be limited to facilitating mid-air transfers solely between two UAVs. The system can be adapted for mid-air transfers from one UAV to multiple other UAVs. These variations fall comfortably within the ambit of the present application without imposing any constraints. Moreover, although the device is depicted as being configured for use among UAVs, system adaptability extends beyond UAVs and encompasses other transportation platforms. In essence, the configurations demonstrated in the figures are illustrative of the systems potential applications but do not limit its functionality to UAV-exclusive scenarios. The disclosure encompasses a broader scope, accommodating various implementations involving different transportation platforms. All such implementations are well within the scope of the present disclosure without any limitations whatsoever.

The manner in which the proposed system for transfer of payload between transportation platforms is further explained in detail with respect to FIGS. 1A to 8. It is to be noted that drawings of the present subject matter shown here are for illustrative purposes only and are not to be construed as limiting the scope of the subject matter claimed. Further, some of the FIGS. may have been explained together, and the same reference numerals may have been used to refer to identical components and entities.

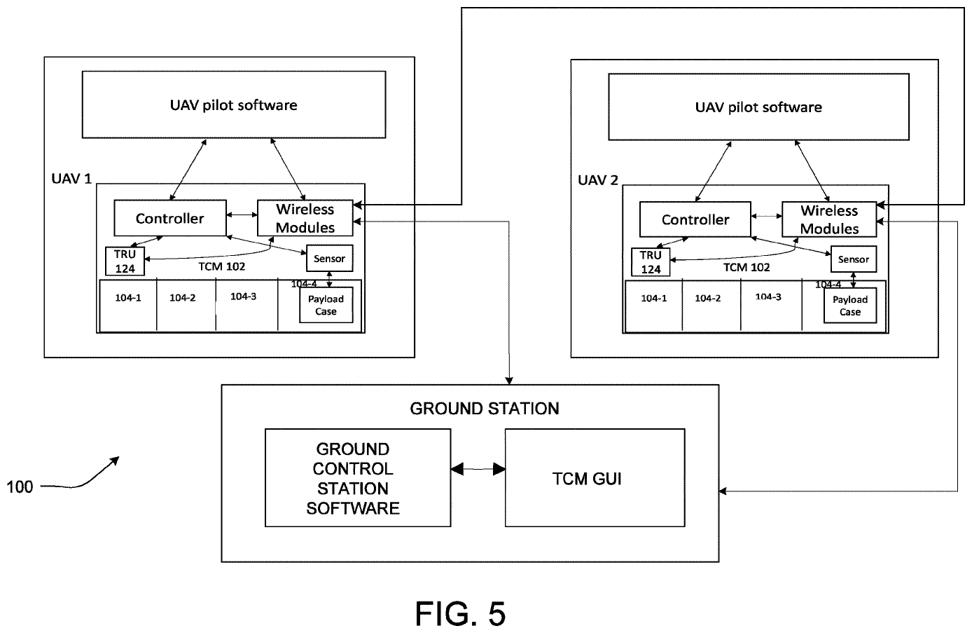

The present invention addresses the challenge of mid-air payload transfer between unmanned aerial vehicles (UAVs). Referring to FIGS. 1A to 8, a system 100 for mid-air transfer of a payload from one unmanned aerial vehicle (UAV) to another is disclosed. The system 100 (as shown in FIG. 5) may include a pair of transfer container modules (TCM 102) (as shown in FIG. 1A and FIG. 1B), each configured with respective UAVs. Each of the TCMs 102 may include a plurality of receptacles 104, each receptacle 104 configured to accommodate a payload case holding the payload and having an open end for entry or exit the payload case. For example, the TCM 102 may equipped with receptacles 104, each capable of accommodating a payload case. In an example, the payload case may provide a standard/uniform enclosure for the objects it holds. Further the standard enclosure is well tuned for entry/exit with receptables 104 and slots 106. In an example, the payload cases are designed to hold delicate instruments securely, ensuring their safety and integrity during mid-air transfers. In an example, the example TCM 102 as shown in FIGS. is rectangular in shape, however the TCM 102 can be configured to adapt shapes based on design requirements, and all such implementations are well within the scope of the present disclosure without any limitations whatsoever.

In an embodiment, each Transfer Container Module (TCM 102) is equipped with multiple receptacles 104, as shown in FIG. 1A, and each receptacle 104 is configured to house a payload case containing the payload. These receptacles 104 have open ends, allowing for the delivery or receipt of the payload case. Additionally, the TCM 102 features a plurality of slots 106 arranged along the length of each receptacle 104. These slots 106 provide access to the desired payload case, enabling the coupling of a transfer means with the payload case. The transfer means, in this context, refers to the device responsible for facilitating the connection and movement of the payload case from one UAV to the other UAV. The arrangement of slots 106 ensures a secure and accessible coupling interface, allowing for the effective transfer of the payload between unmanned aerial vehicles (UAVs).

In an embodiment, the TCM 102 may include a slider (as shown in FIG. 1B) configured to move along a transverse plane of the TCM 102. The slider may be configured to facilitate the precise alignment and positioning of an engaging means 110. The engaging means 110 is configured with the slider and is configured to move in tandem with the slider's motion. For instance, as the slider traverses along the transverse plane, it aligns itself with one of the multiple slots 106 present in the TCM 102. The engaging means 110, configured with the slider, is strategically positioned to interact with the payload case housed within the receptacle 104 associated with the selected slot. Further, the engaging element may have different cross-section and may incorporate various shapes such as circular, square, rectangular, and among others.

In an example, the Transfer Container Module (TCM 102) may incorporate sensors and actuators that are strategically configured within its structure. These sensors and actuators work in conjunction to facilitate the selection of slots 106 by the TCM 102 through a controller. The sensors within the TCM 102 are designed to gather pertinent information, such as the occupancy status of each slot. These sensors may utilize various detection mechanisms, such as limit switches, optical sensors, proximity sensors, or any suitable means for determining the availability of slots 106. Simultaneously, actuators within the TCM 102 respond to signals from the controller. Based on the data received from the sensors, the controller processes the information and generates commands for the actuators. These actuators are responsible for physically manipulating components within the TCM 102 to select a specific slot.

The coordinated action of sensors and actuators, directed by the controller, enables the TCM 102 to dynamically and autonomously choose a slot for the purpose of accommodating a payload case. This functionality enhances the adaptability and efficiency of the mid-air payload transfer system 100 by allowing the TCM 102 to intelligently and flexibly respond to changing operational conditions and payload requirements.

The engagement between the slider's engaging means 110, and the payload case ensures a secure connection and disconnection, enabling the transfer means, such as a sleeve 112, to couple effectively with the payload case. This coordinated movement of the slider and engaging means 110, in conjunction with the slot arrangement, form a robust system 100 for the controlled and efficient mid-air transfer of payloads between unmanned aerial vehicles (UAVs).

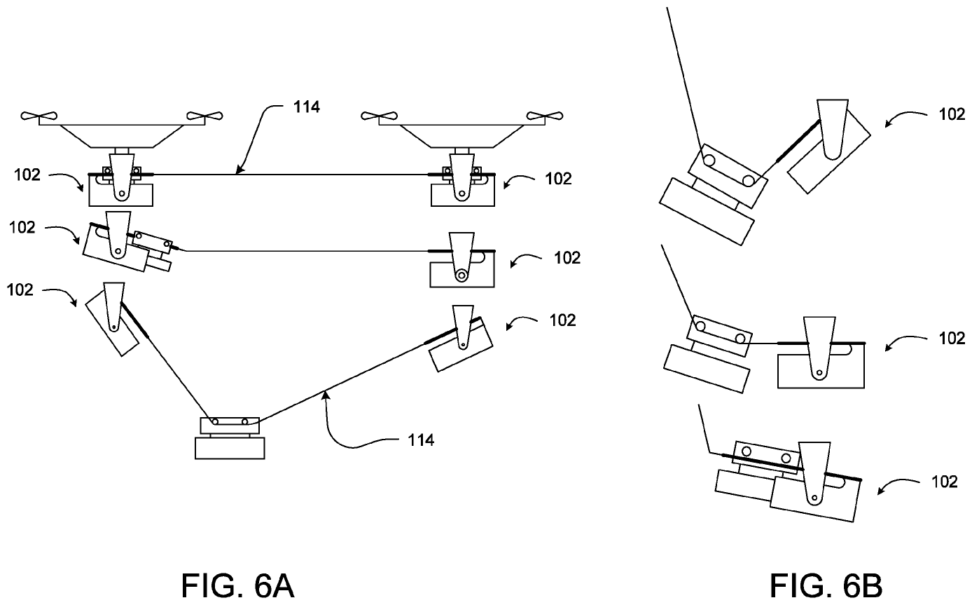

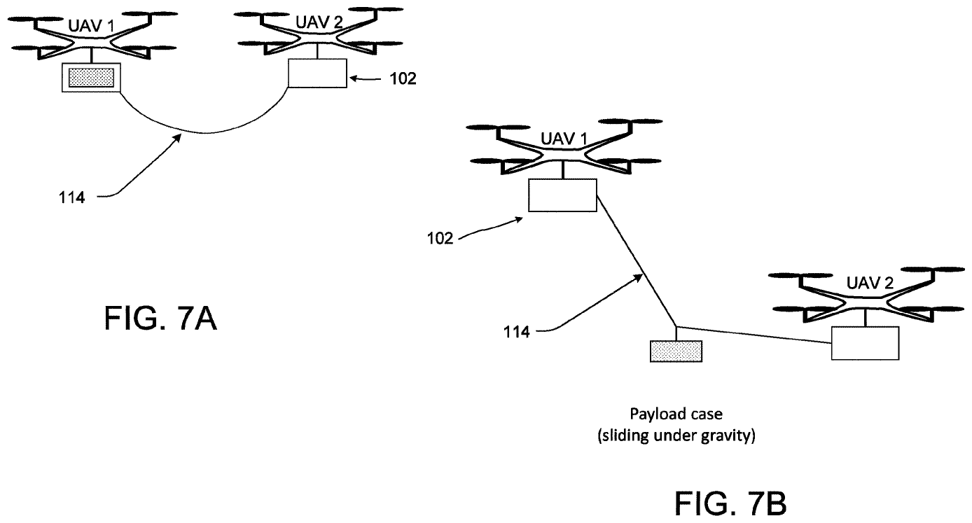

Further, the system 100 involves a flexible link 114 (as shown in 2A-2B and FIG. 6A-7C) that extends from the free end of the engaging means 110 of one of the UAVs of the pair of UAVs. The flexible link 114 may facilitate the transfer of the payload case from one Unmanned Aerial Vehicle (UAV) to another during the mid-air transfer process. Further, the engaging means 110, which is configured with the slider, is equipped with a free end. From this free end, a flexible link 114 extends. This flexible link 114 serves as a physical medium between the engaging means 110 and the sleeve 112, which is part of the transfer means responsible for coupling with the payload case. As the sleeve 112 slides along with the coupled payload case along the engaging means 110, the flexible link 114 accommodates the movement and adjustments required for a seamless transfer process.

In an embodiment, the disclosed TCM 102 may include an engaging means 110 featuring a set of first fingers 116 configured to expand and collapse. Simultaneously, the system 100 includes a sleeve 112 incorporating one or more flaps 130 designed for movement between an extended flap position and a collapsed flap position. The coordinated interaction between the first fingers 116 of the engaging means 110 and the flaps 130 on the sleeve 112 forms an integral part of the mid-air payload transfer operation.

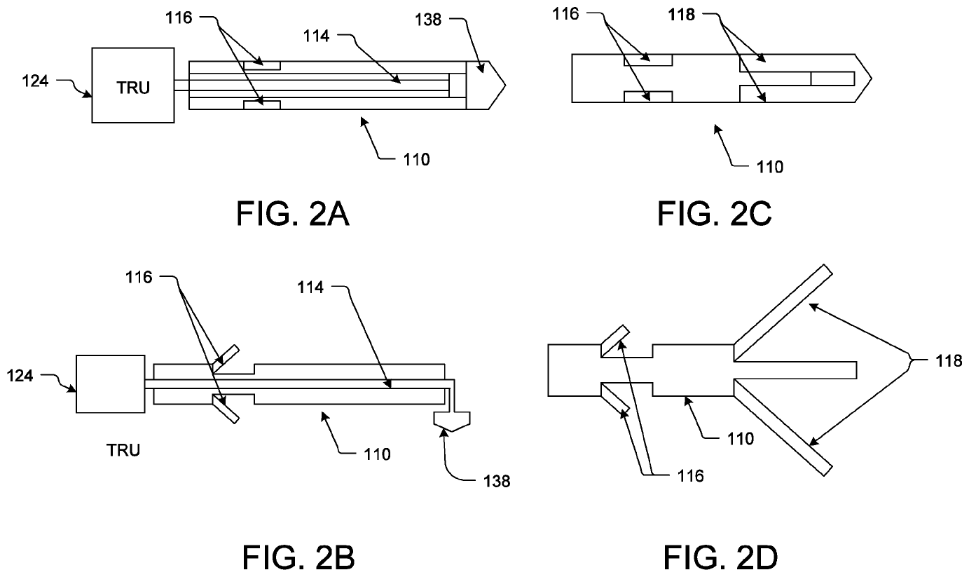

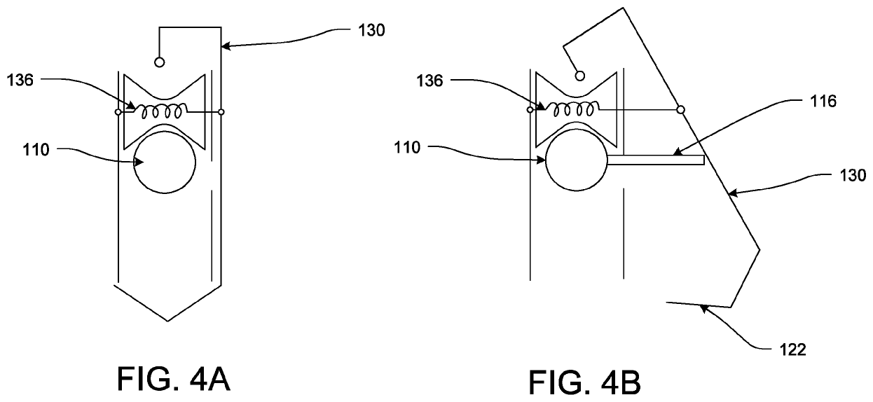

As the first fingers 116 expand (as shown in FIG. 2B and FIG. 2D), they come into contact with the flaps 130 on the sleeve 112 (as shown in FIG. 4B). This interaction triggers the movement of the flaps 130 from a collapsed position to an extended flap position. The expanded state of the flaps 130, in conjunction with the first fingers, establishes a coupled condition. This coordinated coupling mechanism serves as a means to securely couple the sleeve 112 with the payload case during mid-air transfer operations, ensuring a stable and controlled connection.

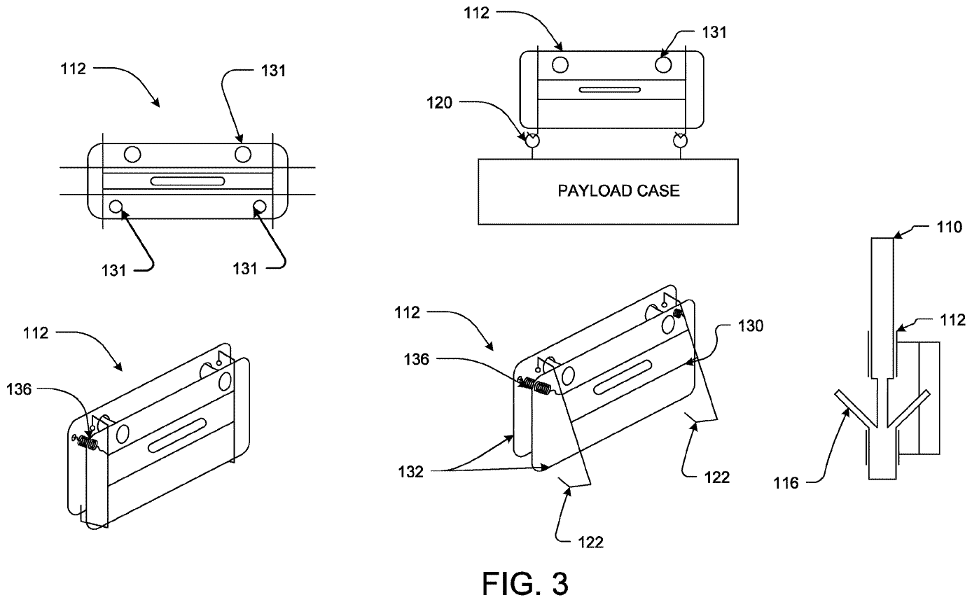

Furthermore, the system 100 incorporates a coupling configuration between the payload case and the sleeve 112. The payload case, situated within the corresponding slot, is equipped with a female coupling means 120 projecting outwards. In complement, the sleeve 112, particularly the flaps 130, features male coupling means 122 (as shown in FIG. 3 and FIG. 4B). The male coupling means 122 on the flaps 130 are strategically fixed to engage with the female coupling means 120 on the payload case. The engagement between the male and female coupling means occurs as the flaps 130 transition from the extended flap position to a collapsed flap position. During this movement, the male coupling means 122 on the flaps 130 effectively connect with the female coupling means 120 on the payload case. This interaction establishes a secure coupling, ensuring the reliable attachment of the sleeve 112 to the payload case during mid-air transfer operations. The movement of flaps 130, and the engagement of male and female coupling means. This carefully orchestrated interplay ensures a dependable and controlled coupling between the sleeve 112 and the payload case.

In one embodiment of the present invention, one of the TCMs 102 of the pair of TCMs 102 includes a tension regulating unit 124 configured with the engaging means 110 to release/retract the flexible link 114. Further, the tension regulating unit 124 enables to ensure smooth entry/exit of the payload case. Firstly, the tension regulating unit 124 (also referred as TRU) is configured to enable the controlled release/retract of a flexible link 114 through the engaging means 110. This controlled release/retract is a pivotal step in initiating and establishing a link between one Unmanned Aerial Vehicle (UAV) and another during mid-air transfer operations. The engaging means 110 collaborates with the tension regulating unit 124 to ensure a precise and controlled deployment of the flexible link 114 from one UAV to another.

Secondly, the tension regulating unit 124 is also configured to adjust the tension in the flexible link 114 after the link has been established between the two UAVs. Once the flexible link 114 is deployed and has created a connection between the TCM 102s of the respective UAVs, the tension regulating unit 124 actively manages and adjusts the tension levels in the flexible link. In an example, the engaging means 110 may adopt a design featuring a hollow rod or telescopic or parallel tubes or any other based on design configuration.

In an embodiment, the engaging means 110 of one of the Transfer Container Modules (TCM 102) in the pair is equipped with a set of second fingers (as shown in FIGS. 2C and 2D) and is configured to grip the flexible link 114 released by the counterpart TCM 102 in the pair. For instance, the second fingers are configured to grasp the flexible link 114 released by the tension regulating unit 124 of the other TCM 102 in the pair. This specific configuration ensures a controlled transfer operation. The engaging means 110, featuring the second fingers, grip and manages the released flexible link. For instance, the second fingers open to be in a ready state to securely grip the hanging flexible link 114 and are structured to close once the flexible link 114 is securely gripped, creating a reliable mechanism for managing the transferred payload.

In an embodiment, the Transfer Container Module (TCM 102) may incorporate one or more gimbals 125, 126 (as depicted in FIGS. 1A and 1B) for mechanical coupling between the pair of TCMs 102 and their respective Unmanned Aerial Vehicles (UAVs). For example, the gimbals 125, 126 provides both free and powered degrees of freedom for rotational movement to the associated TCMs 102/receptables 104 around one or more axes. This dynamic feature enhances the system 100 adaptability, allowing the TCMs 102 to smoothly adjust their orientation in response to evolving operational requirements during mid-air payload transfers (as shown in FIGS. 6A and 6B).

For example, consider a scenario with UAVs hovering in mid-air, each with its TCM 102 attached through the gimbal mechanism. Now, as the UAVs initiate a payload transfer operation, various factors come into play. These could include but are not limited to changes in wind direction, variations in the payload weight, or the need for precise alignment during the transfer. In this scenario, the gimbals 125, 126 play a crucial role. As the UAVs execute the transfer, the gimbals 125, 126 allow the TCMs 102 to adapt seamlessly to these changing operational requirements. For instance, if there's a sudden gust of wind affecting one UAV more than the other, the gimbals 125, 126 permit the TCM 102 on the affected UAV to make real-time adjustments, ensuring that the payload transfer remains stable and controlled. The gimbals 125, 126, with their powered degrees of freedom, empower the TCMs 102 to actively control their orientation (as shown in FIGS. 6A and 6B).

The system may further include a mass adjuster unit 134 (as shown in FIGS. 1A and 1B) to dynamically manage the off-centring of the center of mass during the reception or release of a payload case. The mass adjuster unit 134 may enable mechanical sliding action of the Transfer Control Module (TCM) within a horizontal plane, facilitating meticulous adjustments to counteract any deviations in the center of mass. In an example, during the reception or release of a payload case, the mass adjuster unit 134 responds to variations in the center of mass induced by the payload's weight distribution.

For example, in the event that a payload case is received, which induces a significant displacement of the center of mass. Upon detecting this displacement, the mass adjuster unit 134 initiates the horizontal mechanical sliding of the TCM in a timely manner. The coordinated gliding motion is meticulously adjusted to realign the center of mass to an ideal location, thus guaranteeing equilibrium and steadiness during the mid-air transfer procedure. On the contrary, when a payload case is being released, the mass adjuster unit 134 foresees the forthcoming shift in center of mass and utilizes the TCM's mechanical sliding mechanism to restore equilibrium, thus enabling accurate and regulated mid-air payload transfers.

In another embodiment of the present invention, a sleeve 112 (as shown in FIGS. 3 and FIGS. 4A and 4B) for facilitating the mid-air transfer of a payload from one unmanned aerial vehicle (UAV) to another UAV is disclosed. The sleeve 112 may include a hollow housing 132 slidably configured with an engaging means 110 of a Transfer Container Module coupled to a UAV. For example, the sleeve 112 includes rollers 131 to enable smooth movement of the sleeve 112 over the engaging means 110 and the flexible link. The rollers are incorporated to facilitate smooth movement of the sleeve 112 along the engaging means 110 and the flexible link. The rollers enable minimizing friction and ensure a seamless and controlled payload transfer between UAVs. Further, the rollers may be configured with different shapes to adapt with the engaging element and the flexible link.

In an example, the rollers 131 may be powered for an assisted movement of the sleeve 112 along with the coupled payload case. In this configuration, the rollers may enable assisted movement of the sleeve 112 along with the coupled payload case. The powered rollers enhance the transfer system 100 capabilities by providing controlled and powered assistance during the mid-air transfer, ensuring a precise and responsive payload conveyance between UAVs.

In addition, the sleeve 112 is equipped with one or more flaps 130 that are pivotally fixed to the housing 132, capable of moving between an extended and collapsed position (as represented in FIG. 3) and a male coupling means 122 fixed to the one or more flaps 130 of the sleeve 112. The movement of the flaps 130 between the extended and the collapsed position is enabled by the interplay of the flaps 130 and the first set of fingers of the engaging means 110. When the first set of fingers transitions to an expanded position (as depicted in FIG. 4B), they actively engage with the flaps 130, causing them to extend. Conversely, upon the retraction of the first fingers, the flaps 130, designed with a bias, smoothly move back to the collapsed position. For example, the biasing force responsible for the controlled movement of the flaps 130 may be generated by elements such as spring 136 or similar mechanisms. This biasing force ensures that the flaps 130 reliably return to their collapsed position when not actively engaged.

For an instance, as the one or more flaps 130 shift to the collapsed flap position, the male coupling means 122 on the sleeve 112 connect with the female coupling means 120 on the payload case, facilitating the coupling of the payload case with the sleeve 112. Consequently, the payload case is smoothly conveyed from one Unmanned Aerial Vehicle (UAV) to another UAV, to which the other end of the flexible link 114 is coupled.

In this operational context, the male coupling means 122 and female coupling means 120 collaboratively function as a coupling mechanism. The male coupling means, attached to the one or more flaps 130 of the sleeve 112, effectively engage with the female coupling means 120 projecting from the corresponding slot on the payload case. This interaction occurs when the flaps 130 are in the collapsed flap position, ensuring a secure connection between the sleeve 112 and the payload case.

As the sleeve 112 travels smoothly along the engaging means 110 and the coupled flexible link 114, the payload case is conveyed from the originating UAV to the destination UAV. The other end of the flexible link 114, coupled to the engaging means 110, ensures the coordinated movement of the sleeve 112 and the payload case during the mid-air transfer process. Following this, as the sleeve 112 continues its smooth travel along the engaging means 110 and the flexible link, the payload case is conveyed from one UAV to another. The other end of the flexible link 114 is coupled to the second UAV.

In an embodiment, the housing 132 of the sleeve 112 may include one or more windows. The windows are positioned to allow the set of first fingers 116 of the engaging means 110 to move to the expanded position. This design facilitates enhanced interaction between the first fingers 116 and the flaps 130, ensuring precise engagement and extension. For instance, during the mid-air transfer operation, when the set of first fingers 116 on the engaging means 110 is moved to the expanded position, the windows in the housing 132 come into play. These windows allow a clear path for the movement of the first fingers, enabling them to smoothly and precisely engage with the flaps 130. The design ensures that the first fingers 116 seamlessly reach the extended position, promoting a secure connection/disconnection between the engaging means 110 and the flaps 130 of the sleeve 112.

In another aspect of the present disclosure, a device for establishing a link between a first Unmanned Aerial Vehicle (UAV) and a second UAV, facilitating mid-air payload transfer, is disclosed. The device incorporates a Transfer Container Module (TCM 102), as shown in FIG. 1 and FIG. 2, configured with each of the UAVs, and each TCM 102 is equipped with an engaging means 110.

In an embodiment, the disclosed device comprises a tension regulating unit 124 (as shown in FIGS.) associated with one of the Unmanned Aerial Vehicles (UAVs) among a pair of UAVs. This tension regulating unit 124 is configured to facilitate the controlled release/retract of a flexible link 114 through the engaging means 110. Upon release, the flexible link 114 extends from the free end of the engaging means 110. Concurrently, the other UAV of the other of the first and the second UAV is equipped with a set of second fingers at the free end of its engaging means 110, designed for dynamic movement between open and closed positions to precisely grip the released flexible link.

For example, in operational scenarios involving two UAVs engaged in mid-air payload transfer, the tension regulating unit 124 on one UAV performs controlled release/retract of the flexible link 114 through the inner hollow of its engaging means 110. Simultaneously, the engaging means 110 of the other UAV, with a set of second fingers, grip the flexible link 114 when the second fingers move from open to closed position. This synchronized and controlled release and capture mechanism ensures a secure and reliable mid-air transfer between the UAVs.

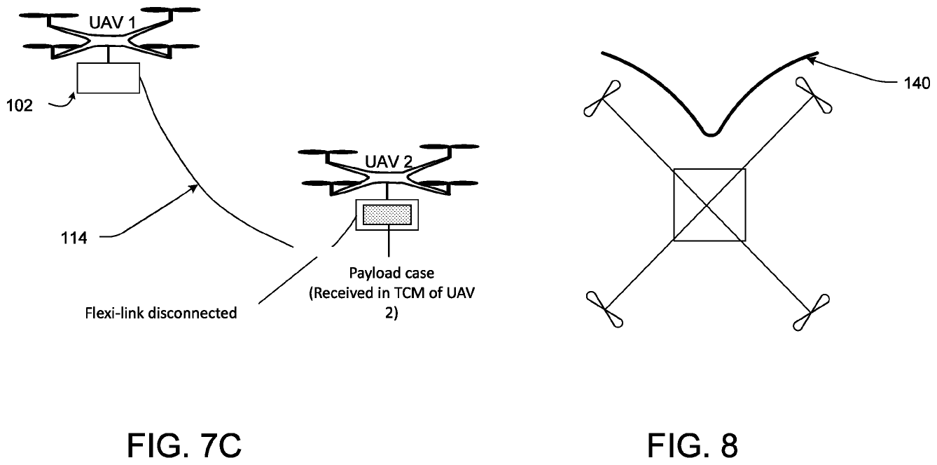

Furthermore, the other UAVs of the other of the first and the second UAVs incorporate a V-shaped guide 140 configuration (as shown in FIG. 8). This guide is devised to guide the flexible link 114 towards the free end of the engaging means 110, achieving precise capture. Additionally, it acts as a protective guard, preventing potential interference of the flexible link 114 with the propellers on the corresponding UAV. This protective design enhances the overall safety and reliability of the mid-air payload transfer system 100.

In the disclosed exemplary embodiment, as illustrated in FIGS. 6 and 7, the system 100 showcases UAV 1 and UAV 2 designed for mid-air payload transfer between unmanned aerial vehicles (UAVs). Each UAV, denoted as UAV 1 and UAV 2, integrates a Transfer Container Module (TCM 102). The TCM 102 as shown in FIGS. 1A and 1B, incorporates components, including but not limited to a controller, wireless communication means, and an array of sensors strategically placed in each slot to ascertain vacancy status.

In an exemplary embodiment, when considering a pair of UAVs, a specific configuration is established where one UAV functions as the master UAV, while the other serves as the slave UAV. The master UAV is equipped with essential components, including a Tension Regulating Unit (TRU), a Flexi Link, and a stopper 138. The TRU is responsible for regulating tension, the Flexi Link facilitates the connection between the two UAVs, and the stopper 138 ensures a secure attachment during the payload transfer process. Conversely, the slave UAV in this configuration incorporates V-shaped guides 140 and a set of second fingers within the engaging element. These components on the slave UAV are instrumental in receiving and gripping the Flexi Link released by the master UAV. Additionally, the slave UAV is equipped with cameras dedicated to image analytics, enabling functionalities such as searching, alignment, and other visual-based operations during the payload transfer process.

The communication network within the system 100 involves the TCM 102 controller establishing communication with the UAV's auto-pilot or pilot software. The system may also include one or more sensors positioned in the engaging element, TCM, gimbal positions, and tension adjusting unit. These sensors are in constant communication with the controller, relaying information pertaining to one or more operations within the system. The pilot software may manage flight dynamics and altitude control, ensuring precise adjustments during mid-air transfers. Wireless communication modules are utilized to enable communication between one or more UAVs and perform one or more operations.

In an embodiment, the system may be configured to achieve precise positioning and alignment between UAV 1 and UAV 2. Upon attaining the accurate position and alignment, the controller on UAV 1 issues a signal to a tension-regulating unit 124, which is equipped with engaging means 110 on UAV 1, resulting in the release of the flexible link. The engaging means 110 of one TCM 102 captures the flexible link 114 released by the other TCM 102 using a second set of fingers, and the system 100 autonomously maintains a tension value range through the combined effect of TRU and adjustments to the distance/altitude between UAV 1 and UAV 2.

With the flexible link configured between UAV 1 and UAV 2, the release of the payload is orchestrated by activating a latch, facilitating the payload's-controlled transfer from UAV-1 to UAV-2 under the influence of gravity. This process is guided by sleeve 112, as illustrated in FIGS. 3, FIG. 4A, and FIG. 4B. Following arrival in a corresponding slot in UAV 2, the payload case is detected by a sensor and secured in place by actuating the corresponding latch. After the completion of the transfer, a wireless message is relayed, prompting the release of the flexi link by the UAV-2 and retraction of flexi-link by UAV 1.

Subsequently, UAVs are decoupled and can autonomously navigate in their respective directions.

In an embodiment of the present invention, the initiation of a payload transfer process by UAV 1/UAV 2 is autonomously carried out or triggered through the ground control software (GCS). The system 100 is specifically configured to compute meeting points, encompassing latitude, longitude, altitude, and heading, for both UAV 1 and UAV 2. As an illustration, UAV 1/UAV 2, equipped with the payload, takes off and reaches its designated position as specified by the GCS. Upon reaching their respective positions, either UAV 1/UAV 2 or both UAVs may commence a search for each other, utilizing GPS positions, beacon signals, and image analytics. Once identified, the UAVs begin the process of aligning with each other.

In an example scenario, such as the one illustrated in FIG. 7A, where UAV 1 is configured to carry a payload and transfer it to UAV 2, the GCS or the embedded controller in UAV 1 communicates with the Transfer Container Module (TCM 102) of one of the UAVs to release the Flexi Link. For instance, UAV 1 may release the flexi link, causing it to hang vertically below, and subsequently informs UAV 2 to approach and grip the vertically hanging Flexi Link. UAV 2 moves forward and, using the V-shaped guide 140, centres the flexi link, which is now within the reach of the second fingers. After gripping the flexi link, UAV 2 moves back, creating sufficient tension in the Flexi Link, causing the stopper 138 at the end of the Flexi Link to become lodged in the TCM 102 rod of UAV 2.

The progression of the payload case transfer between the Transfer Container Modules (TCMs) 102 of UAV-1 and UAV-2 utilizing the flexi-link is illustrated in FIGS. 7A to 7C. In FIG. 7A, UAV-1 and UAV-2 are aligned in relation to each other. FIG. 7B demonstrates UAV-1 ascending to a higher altitude, leading to the release of the payload case from TCM 102. Alternatively, UAV 1 may adjust the orientation of the TCM using gimbals to release the payload case. Subsequently, the payload case descends along the flexi-link due to gravity, reaching and being received within one of the receptacles of TCM 102 of UAV-2, upon completion of transfer of the payload case, the flexi link can be disconnected as depicted in FIG. 7C.

Moreover, both UAV 1 and UAV 2 may integrate image analytics circuitry to execute tasks such as mutual searching, self-alignment, and could include beacon circuitry for mutual localization. The controller of TCM 102 is responsible for tasks like identification, authentication, internal operations, and communication with the respective auto-pilot systems of the UAVs and other TCMs 102 through wireless modules. Further, the control scope of the TCM 102 controller extends to various components, encompassing, but not restricted to, the TCM 102 Gimbals 125, 126, limit switches, sliders, and latches on the transfer container module.

Further, the overall system 100 is configured for autonomous mid-air payload transfer between UAVs and can be effectively controlled by a ground station. This ground station is equipped with ground control software (GCS) and a graphical user interface (GUI), providing operators with the capability to serve as the command centre which co-ordinates the payload transfer process and to control/monitor the health status of the TCM 102 during operations.

Consequently, the present invention described above addresses deficiency in the current realm of unmanned aerial vehicle (UAV) cargo transportation system by introducing a system 100 for the mid-air transfer of payloads between UAVs. It effectively mitigates the limitations inherent in existing technologies. The invention comprises a pair of transfer container modules (TCM 102s) equipped with receptacles 104 for payload cases, each featuring slots 106, sliders, sleeve 112, and flexible links. The engaging means 110 of the sliders facilitate the transfer of payload cases between UAVs.

The system 100 also incorporates tension-adjusting devices and gimbals 125, to enhance control and adaptability. The accompanying sleeves 112 incorporate flaps 130 and hooks for secure payload attachment, and powered rollers ensure smooth movement. The engaging means 110 of the TCMs 102 include first and second fingers for precise coupling and release of flexible links, enabling mid-air payload transfers. Thus, providing seamless mid-air payload exchanges between UAVs, offering unparalleled operational efficiency, adaptability, and versatility in applications such as cargo transport and surveillance, thereby fundamentally transforming the capabilities of UAVs in dynamic operational scenarios.

### Advantages of the Invention

The present disclosure provides a simple, time-saving, and efficient system for the transfer of payload mid-air between unmanned aerial vehicles.

The present disclosure provides a system with a slider mechanism and engaging means, providing precise alignment and controlled interaction with payload cases during mid-air transfers.

The present disclosure provides a system with protective features such as V-shaped guards and prevents interference with UAV propellers, enhancing overall safety during mid-air payload transfers.

The present disclosure provides a system that incorporates gimbals providing free and powered degrees of freedom for rotational movement. This adaptability allows the system to adjust to changing operational requirements, ensuring stability under different conditions.

The present disclosure provides a system with Tension-regulating units for the controlled release of flexible links, allowing for dynamic adjustment of tension levels.

The incorporation of rollers on the sleeves enables smooth and assisted movement along the engaging means and flexible links. This feature minimizes friction and ensures a seamless transfer process between UAVs.

The present disclosure increases the range of operation of the UAV and significantly increases the valuable uptime of the UAVs.

The present disclosure minimizes the need for frequent battery changes, thereby reducing unnecessary trips for battery replacements. This results in achieving specific missions with a smaller inventory of in-circulation batteries.

The present invention provides a system that enhances user experience by providing a reliable and user-friendly solution for aerial payload transfer.

I claim:

1. A system (100) for mid-air transfer of a payload from one unmanned aerial vehicle (UAV) to another, the system (100) comprising:
a pair of transfer container modules (102) (TCM), each of the TCM (102) comprising:
a plurality of receptacles (104), each receptacle (104) configured to accommodate a payload case holding the payload and having an open end for entry or exit of the payload case;
a plurality of slots (106) configured on the TCM (102) along a length of each of the receptacle (104), wherein the plurality of slots (106) provide an access to the payload case for coupling of a transfer means with the payload case;
a slider (108) configured to move along a transverse plane of the TCM (102), the slider (108) comprising an engaging means (110) and is configured to move along with the slider (108) to align with one of the plurality of slots (106); and
a flexible link (114) extending from a free end of the engaging means (110) to facilitate the transfer of the payload case from one UAV to another UAV by sliding the sleeve (112) along with the coupled payload case along the engaging means (110) and the flexible link; and
a sleeve (112) slidably configured with the engaging means (110) and functioning as the transfer means to couple with the desired payload case.

2. The system (100) as claimed in claim 1, wherein the engaging means (110) comprises a set of first fingers (116) configured to expand and collapse, and the sleeve comprises one or more flaps such that, the first fingers, when the first fingers expand, engage with the one or more flaps to move the flaps to an expanded flap position, wherein the first fingers and the flaps function as a means to couple the sleeve (112) with the payload case.

3. The system (100) as claimed in claim 1, wherein the payload case comprises a female coupling means that project out from the corresponding slot, and the sleeve comprises a male coupling means fixed to the one or more flaps of the sleeve such that when the flaps move from the expanded flap position to a collapsed flap position, the male engaging means engage with the female coupling means to couple the payload case with the sleeve (112).

4. The system (100) as claimed in claim 1, wherein one of the TCMs (102) of the pair of TCMs (102) comprises a tension regulating unit (124) configured with the engaging means (110) to release the flexible link (114), as well as to adjust tension in the flexible link after a link is established between one unmanned aerial vehicle (UAV) to another.

5. The system (100) as claimed in claim 1, wherein the engaging means (110) of one TCM (102) of the pair of TCMs (102) comprises a set of second fingers (118) configured to grip the flexible link (114) released by the other of the TCMs (102) of the pair of TCMs (102).

6. The system (100) as claimed in claim 1, wherein the engaging means (110) comprises a plurality of concentric/parallel tubes and wherein the flexible link (114) from the tension regulating unit (124) to the free end of the engaging means (110) is accommodated within the concentric/parallel tubes.

7. The system (100) as claimed in claim 1, comprising one or more gimbals (125, 126) to mechanically couple the one or more TCMs (102) of the pair of TCMs (102) to the corresponding UAVs, wherein the gimbals (125, 126) provide free or powered degrees of freedom of rotation to the corresponding TCM (102) about one or more rotational axes.

8. The system (100) as claimed in claim 1, comprising a mass adjuster unit (134) configured to dynamically adjust the off-centering of the center of mass during the reception or release of a payload case.

9. A sleeve (112) for facilitating mid-air transfer of a payload from one unmanned aerial vehicle (UAV) to another UAV, the sleeve (112) comprising:
a hollow housing (132) slidably configured with an engaging means (110) of a Transfer Container Module (102) coupled to a UAV;
one or more flaps (130) pivotally fixed to the housing (132) for movement between an extended position and a collapsed position, and biased to remain in the closed position; and
a male coupling means (122) fixed to the one or more flaps (130) of the sleeve (112);
wherein when a set of first fingers (116) of the engaging means (110) are moved to an expanded position, the set of first fingers (116) engage with one or more flaps (130) to move the flaps (130) to the expanded flap position, and when the set of first fingers (116) are moved back, the one or more flaps (130) move back to the collapsed flap position under a biasing force, and
wherein, when the one or more flaps (130) move to the collapsed flap position, the male coupling means engage with the female coupling means to couple the payload case with the sleeve (112) such that when the sleeve (112) moves along the engaging means (110) and a flexible link (114) coupled to the engaging means, the payload case is carried from the UAV to another UAV to which other end of the flexible link (114) is coupled.

10. The sleeve (112) as claimed in claim 9, wherein the sleeve (112) comprises rollers (131) to enable smooth movement of the sleeve (112) over the engaging means (110) and the flexible link (114).

11. The sleeve (112) as claimed in claim 10, wherein the rollers (131) are powered for an assisted movement of the sleeve (112) along with the coupled payload case.

12. The sleeve (112) as claimed in claim 9, wherein the housing (132) comprises one or more windows through which the set of first fingers (116) of the engaging means (110) move to the expanded position to engage with the one or more flaps (130).

13. A device for establishing a link between a first Unmanned Aerial Vehicle (UAV) and a second UAV for mid-air transfer of a payload between the UAVs, the device comprising:
a transfer container module (TCM) (102) configured with each of the first and the second UAV, each of the TCM (102) comprising an engaging means (110);
a tension regulating unit configured with the TCM (102) of one of the first and the second UAV, the tension regulating unit being configured to release a flexible link (114) as well as to adjust a tension in the flexible link after a link is established between the first UAV and the second UAV, such that the flexible link (114) passes through the engaging means (110) of the corresponding TCM (102) with a free end of the flexible link (114) hanging out of a free end of the engaging means; and
a set of second fingers (118) provided at a free end of the engaging means (110) of the TCM (102) of the other of the first and the second UAV, the set of second fingers (118) configured to move between an open position and a closed position to grip the flexible link.

14. The device as claimed in claim 13, wherein the other of the first and the second UAV comprises a V-shaped guide (140) configured to direct the flexible link (114) towards the free end of the engaging means (110).
